(19) United States
(12) Patent Application Publication
(10) Pub. No.: US 2014/0128090 A1
(43) Pub. Date: May 8, 2014

(54) METHOD AND DEVICE FOR SHARING MOBILE FEMTOCELL NETWORK

(71) Applicant: Jaewon Lim, Anyang-si (KR)

(72) Inventor: Jaewon Lim, Anyang-si (KR)

(73) Assignee: LG ELECTRONICS INC., Seoul (KR)

(21) Appl. No.: 14/129,218

(22) PCT Filed: Apr. 5, 2012
(86) PCT No.: PCT/KR2012/002591

§ 371 Date: Dec. 24, 2013

Related U.S. Application Data
(60) Provisional application No. 61/501,243, filed on Jun. 26, 2011.

(51) Int. Cl. H04W 52/24

(52) U.S. Cl. CPC H04W 52/243
USPC 455/452.2; 455/561

(57) ABSTRACT

The present invention relates to a method for sharing a femtocell network, and more specifically, to a method and device for sharing a mobile femtocell network. The method relates to a method in a mobile femtocell base station, and includes the steps of: receiving information about a service level of a neighboring mobile femtocell in the mobile femtocell base station; determining the service level of the neighboring mobile femtocell based on the information; and transmitting a transmission power control request about the neighboring mobile femtocell to a femtocell network controller to reduce interference of the neighboring mobile femtocell according to the determination result.

### FIELD OF THE INVENTION

The present invention relates to a method for sharing a femtocell network, and more particularly to a method and apparatus for sharing a mobile femtocell network.

### BACKGROUND ART

Increasing competition and reducing profitability of a communication market, diversification of user demands, increasing communication charges, and development of wired/wireless communication technologies are expediting appearance and development of various convergence services. Specifically, the current of communication markets called wired/wireless integration has been highlighted as a paradigm for creating a new service while simultaneously preventing secession of legacy subscribers.

The wired/wireless integration is generally classified into fixed mobile convergence (FMC) and fixed mobile substitution (FMS). FMC refers to a wired/wireless integration service in which a user located outdoors, who carries one terminal, can make a phone call to another party through a mobile communication network, and a user located indoors, who carries one terminal, can make a phone call to another party through a public switched telephone network (PSTN) or an Internet Protocol (IP) network. FMS refers to a mobile communication network service in which mobile communication charges at a specific region (such as an indoor space of a household) are cheaper than communication charges of a wired service such that it can substitute for some parts of the wired service.

A femtocell serving as one of FMC technologies may refer to an indoor base station (BS) configured to connect to a mobile communication core network through a commercial broadband wired Internet network. Due to introduction of femtocell, enterprises can improve a communication quality and a service quality at lower prices as well as to extend cell coverage, as compared to a legacy macrocell/

A mobile femtocell or a mobile femtocell base station (BS) indicates that a legacy femtocell has mobility. Differently from a general femtocell, a mobile femtocell is connected to a macro base station (BS) through a mobile communication core network (CN) according to a mobile communication access scheme instead of a broadband access scheme, such that the mobile femtocell communicates with the mobile communication core network (CN) through the macro BS.

Recently, arrangement of wireless access point (APs) of enterprises who use the same one frequency band has come into widespread use in the same manner as in a Wireless LAN (WLAN). In addition, as the number of users who simultaneously use a plurality of wireless communication devices is rapidly increasing, the number of mobile APs (or mobile femtocells) carried by users who are moving is also rapidly increasing.

The above-mentioned tendency has been accelerated as a mobile AP function is added to smartphones. As a result, under the situation that multiple mobile APs are located at one place, interference between mobile APs configured to use the same frequency encounters serious problems.

### DETAILED DESCRIPTION OF THE INVENTION

### Technical Problem

An object of the present invention is to provide a method and apparatus for minimizing interference between a mobile femtocell and a neighbor mobile femtocell and at the same time sharing a femtocell network.

### Technical Solution

The object of the present invention can be achieved by providing a method for sharing a mobile femtocell network by a mobile femtocell base station (BS) including: receiving, by the mobile femtocell BS, information on a service level (SL) of a neighbor mobile femtocell; determining a service level of the neighbor mobile femtocell on the basis of the information on the service level (SL); and transmitting a transmission (Tx) power control request of the neighbor mobile femtocell to a femtocell network controller (FNC) so as to reduce interference associated with the neighbor mobile femtocell according to the determined result.

Preferably, the mobile femtocell BS may be a mobile access point (AP). The mobile femtocell BS may be connected to a femtocell network controller (FNC) of a mobile communication core network (CN) through a macro BS.

Preferably, the mobile femtocell BS may communicate with UE (user equipment)s using either a mobile communication connection scheme or a WLAN scheme. The neighbor mobile femtocell BS may periodically transmit its own system information including the service level (SL).

Preferably, the service level (SL) may correspond to priority in which a mobile femtocell BS having a higher SL is able to transmit at a higher transmission (Tx) power than a neighbor mobile femtocell having a lower SL. The service level (SL) may be set based on an accounting (or charging) level of a user.

Preferably, the femtocell network controller (FNC) may be present independently, or may be integrated with a mobile management entity (MME) of a mobile communication core network (CN).

Preferably, the information on the service level (SL) of the neighbor mobile femtocell may be received through a user equipment (UE) or is directly received by the mobile femtocell BS.

Preferably, the transmitting the transmission (Tx) power control request for the neighbor mobile femtocell to the FNC may include: if a service level of the neighbor mobile femtocell is lower than that of the mobile femtocell BS, transmitting a request for reducing transmission (Tx) power of the neighbor mobile femtocell to the femtocell network controller (FNC).

### Effects of the Invention

As is apparent from the above description, the method for sharing a mobile femtocell network according to exemplary embodiments of the present invention have the following effects. When a mobile femtocell recognizes a neighbor mobile femtocell, the mobile femtocell receives a service level of the neighbor mobile femtocell, a transmit (Tx) power of the neighbor mobile femtocell is adjusted according to a service level, interference between mobile femtocells can be minimized and the femtocell network can be shared between the mobile femtocells.

### BRIEF DESCRIPTION OF THE DRAWINGS

FIG. 1 is a conceptual diagram illustrating virtualization of a radio network physical network according to the related art.

FIG. 2 is a conceptual diagram illustrating a connection shceme of mobile femtocells according to the related art.

FIG. 3 is a conceptual diagram illustrating a method for controlling neighbor-cell transmit (Tx) power according to a service level according to an embodiment of the present invention.

FIG. 4 is a flowchart illustrating a method for controlling neighbor-cell Tx power according to a service level according to an embodiment of the present invention.

### BEST MODE FOR CARRYING OUT THE INVENTION

While the present invention permits a variety of modifications and changes, specific embodiments of the present invention illustrated in the drawings will be described below in detail. However, the detailed description is not intended to limit the present invention to the described specific forms. Rather, the present invention includes all modifications, equivalents, and substitutions without departing from the spirit of the invention as defined in the claims.

In description of the present invention, the terms “first” and “second” may be used to describe various components, but the components are not limited by the terms. The terms may be used to distinguish one component from another component. For example, a first component may be called a second component and a second component may be called a first component without departing from the scope of the present invention. The term “and/or” may include a combination of a plurality of items or any one of a plurality of items.

In the case in which a component is “connected” or “coupled” to another component, the components may be connected or coupled to each other directly or via an interposing component. In the case in which a component is “directly connected or coupled” to another component, it will be understood that an interposing component is not present.

The terms used in the present application are merely used to describe specific embodiments and are not intended to limit the present invention. A singular expression may include a plural expression unless otherwise stated in the context. In the present application, the terms “including” or “having” are used to indicate that features, numbers, steps, operations, components, parts or combinations thereof described in the present specification are present and presence or addition of one or more other features, numbers, steps, operations, components, parts or combinations are not excluded.

Unless otherwise defined, all terms used herein, including technical or scientific terms, have the same meaning as those understood by those skilled in the art. Terms defined in a generally used dictionary may be analyzed to have the same meaning as the context of the relevant art and may not be analyzed to have ideal meaning or excessively formal meaning unless clearly defined in the present application.

Exemplary embodiments of the present invention will be described below in detail with reference to the accompanying drawings in which the same reference numbers are used throughout this specification to refer to the same or like parts. In describing the present invention, a detailed description of known functions and configurations will be omitted when it may obscure the subject matter of the present invention.

Recently, arrangement of wireless access point (APs) of enterprises who use the same one frequency band has come into widespread use in the same manner as in a Wireless LAN (WLAN). In addition, as the number of users who simultaneously use a plurality of wireless communication devices is rapidly increasing, the number of mobile APs (or mobile femtocells) carried by users who are moving is also rapidly increasing. The above-mentioned tendency has been accelerated as a mobile AP function is added to smartphones. As a result, under the situation that multiple mobile APs are located at one place, interference between mobile APs configured to use the same frequency encounters serious problems.

In order to solve the above-mentioned problems, the present invention defines a method for controlling Tx power of a mobile AP according to a service level promised between a user and a communication enterprise under the condition that a specific mobile AP user is adjacent to an AP of another user. In addition, if the presence of a neighbor mobile AP instead of a mobile AP is detected, a method for controlling Tx power according to a service level agreement (SLA) between the mobile AP and the neighbor mobile AP is defined.

That is, if it is recognized that a specific mobile AP user is located adjacent to another user AP (i.e., a mobile AP or a stationary AP) while in motion, a method for controlling interference between a mobile AP and a neighbor user AP by adjusting Tx power through mutual negotiation between the mobile AP and the neighbor user AP is defined. In addition, Tx power can be adjusted according to whether the neighbor AP user has been made a contract with the same enterprise or according to whether the corresponding AP has mobility.

Generally, although the term “SLA” refers to a contract regarding a network usage between the enterprises, the SLA is defined as a service level at which a user registered in a network of the enterprises can receive a desired service. The SLA level of a user may be changed according to a payment (or accounting) level and a user-registered geolocation, etc. That is, a user who has paid a high price is assigned a high service level, and a user who has paid a low price is assigned a low service level. A user registers a location of a specific range, such that the user can receive a service having a high service level within the corresponding region. Here, the high service level may refer to a high throughput, a low delay, etc.

For reference, although a mobile AP and a mobile femtocell may be implemented in different ways, the mobile AP and the mobile femtocell can have the same operation scheme so as to provide a communication service to a specific UE while in motion. As a result, when describing technology proposed by the present invention, the mobile AP and the mobile femtocell are used interchangeably so as to represent the same meaning.

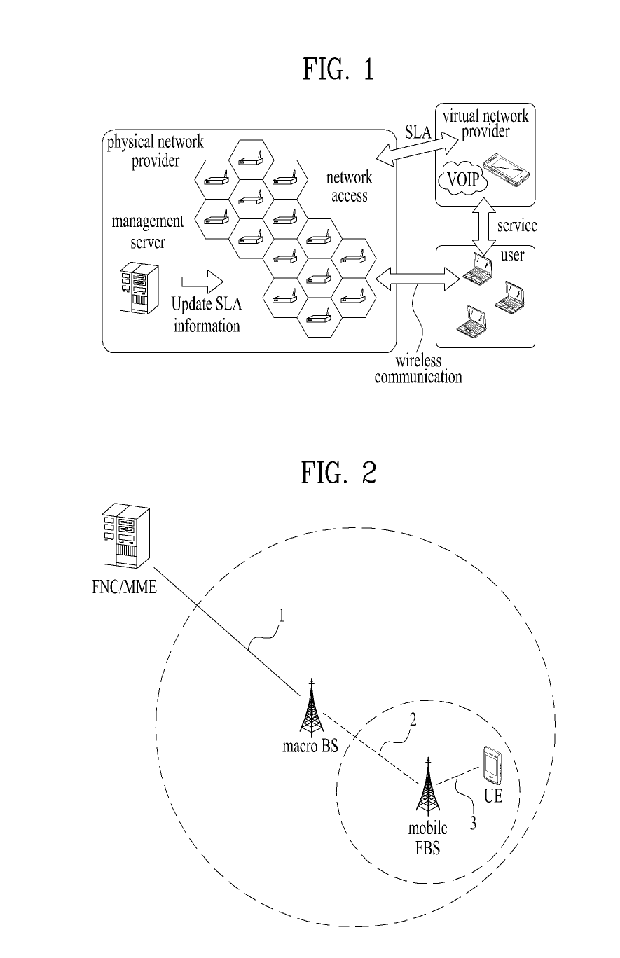

FIG. 1 is a conceptual diagram illustrating virtualization of a radio network physical network according to the related art.

Network virtualization may indicate that several service providers divide networks of one or more physical network providers into a plurality of heterogeneous virtual networks, so as to provide the end-to-end services having different characteristics. Network virtualization may include that resources of such virtualization network are effectively shared and used.

That is, the term “virtualization” indicating a background art of this specification may be defined as a technology for hiding physical characteristics of resources from a user while simultaneously exposing only logical resources to the user. In this specification, virtualized resources are a radio network infrastructure such as an access point (AP) or a base station (BS), groups having different purposes share the same radio network infrastructure so that the groups may independently use the radio network infrastructure.

Referring to FIG. 1, a radio network virtualization system includes a physical network enterprise, a virtual network enterprise, and a general user. The virtual network enterprise who desires to provide either a Voice over Internet Protocol (VoIP) or a streaming service does not have an actual physical network infrastructure, constructs a virtual network over a physical network through a contract with the physical network enterprise having the infrastructure, such that the virtual network enterprise can provide the above-mentioned service to a general user. This contract between the virtual network enterprise and the physical network enterprise is referred to as a service level agreement (SLA).

The above-mentioned system can more efficiently manage the radio network, irrespective of whether the system operates in a legacy communication network and throughput improvement of the system is achieved, such that it can achieve a higher commercial value and a probability of pursuit of profits. However, in order to support the presence of a virtual network enterprise seldom handled in the legacy system, the physical network enterprise must enable the radio network infrastructure to be shared by several virtual network enterprises. In more detail, the physical network enterprise must enable the radio network infrastructure to be shared by users who receive services of the virtual network enterprise in response to the SLA. That is, according to exemplary embodiments, it is necessary for the radio network infrastructure such as Access Point (AP) or Base Station (BS) to be shared by different groups.

FIG. 2 is a conceptual diagram illustrating a connection shceme of mobile femtocells according to the related art.

In more detail, an exemplary scheme for connecting a mobile femtocell (or a mobile femtocell BS) to each network element through a network is shown in FIG. 2. The mobile femtocell is connected to a femtocell network controller (FNC) of a mobile communication core network (CN) through a macro BS in step 1. In this case, the macro BS is connected to a mobile femtocell (or a mobile femtocell BS) according to the mobile communication connection scheme in step 2. The mobile femtocell may communicate with UEs according to the mobile communication connection scheme (e.g., cellular communication scheme), or may communicate with the UEs according to the WLAN scheme in step 3.

The femtocell network controller (FNC) may be present independently, or may be integrated with a Mobile Management Entity (MME) of a mobile communication core network (CN). According to the present invention, irrespective of whether the femtocell network controller is present independently, the term femtocell network controller will hereinafter be referred to as FNC for convenience of description.

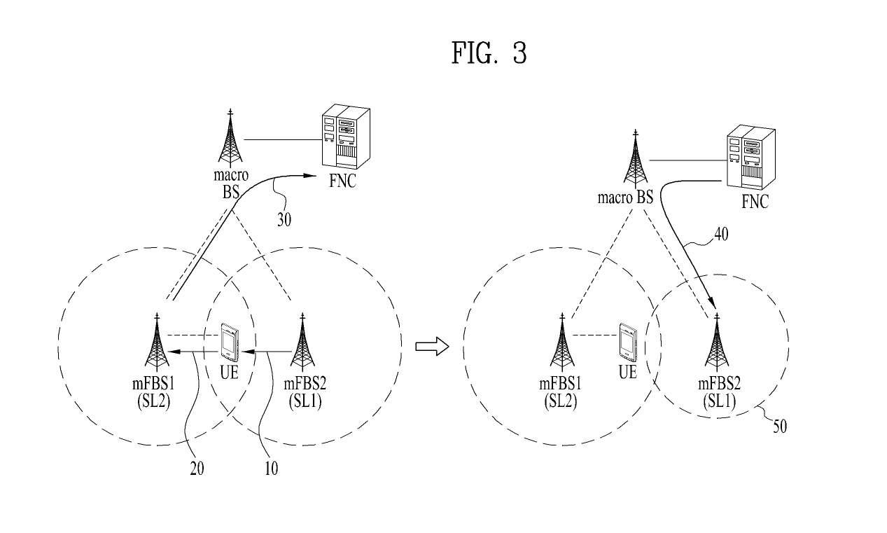

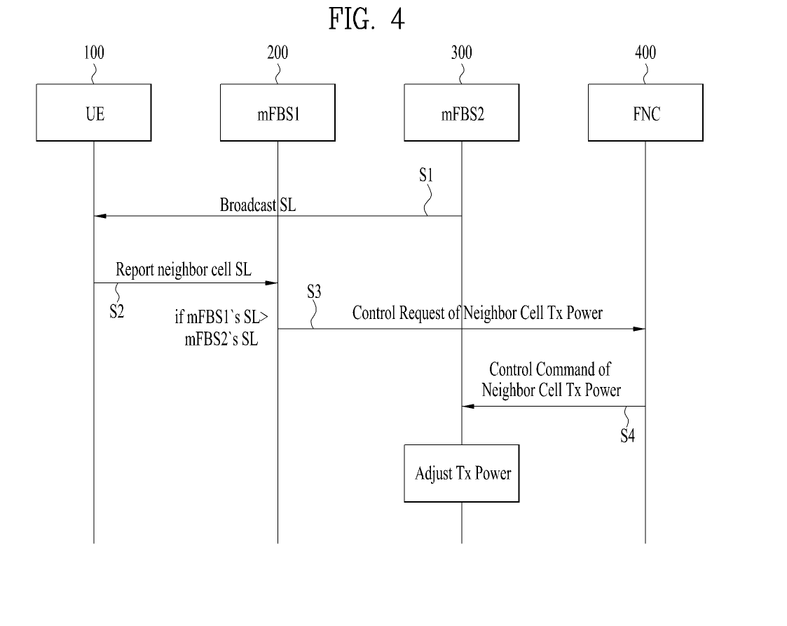

FIG. 3 is a conceptual diagram illustrating a method for controlling neighbor-cell transmit (Tx) power according to a service level according to an embodiment of the present invention.

According to an exemplary method of FIG. 3, when two mobile femtocells or mobile femto BSs are adjacent to each other while in motion in such a manner that there arises interference between the mobile femtocells or the mobile femtocell BSs, a method for controlling Tx power of the neighbor cell according to a service level is shown in FIG. 3.

That is, it can be recognized that the mobile femtocell (mFBS1) is located adjacent to a mobile femtocell (mFBS2) and the mFBS1 can recognize a service level of the mFBS2 through a UE in step 10. In other words, a UE connected to the mFBS1 can receive system information periodically transmitted from the mFBS2 by periodically searching for the presence or absence of a neighbor cell, and reports a service level of the mFBS2 contained in the system information to the mFBS1.

When a service level of the mFBS2 is lower than that of the mFBS1 in step 20, assuming that the amount of interference applied to either the mFBS1 or a UE connected to the mFBS1 is very large, the mFBS1 transmits a request signal for reducing mFBS Tx power to the FNC in step 30. The femtocell network controller (FNC) having received the Tx power limitation request of a neighbor cell from the mFBS1 confirms service levels of the mFBS1 and the mFBS2, such that the FNC can confirm whether the corresponding request is justifiable. If the corresponding request is justifiable, the FNC transmits a request for reducing Tx power to the mFBS2 in step 40, and the mFBS2 having received the Tx power limitation request reduces its own Tx power and performs communication in step 50.

Referring to FIG. 3, the mFBS periodically includes a service level value in its own system information, such that it periodically transmits the resultant system information. If the mFBS2 does not transmit the service level value, the mFBS1 informs the FNC of the presence of mFBS2 adjacent to the mFBS1. If a service level of the mFBS2 is lower than that of the mFBS1, the mFBS2 outputs a request for reducing Tx power of the mFBS2.

FIG. 4 is a flowchart illustrating a method for controlling neighbor-cell Tx power according to a service level according to an embodiment of the present invention.

FIG. 4 shows various procedures for implementing the scheme proposed by the present invention. A UE 100 receives a service level (SL) of a neighbor cell in step S1, and reports the SL to the mFBS1 200 connected to the UE in step S2. In this case, the scheme for receiving a service level (SL) value of the neighbor cell may be searched for by the UE according to a function or current position of the mobile femtocell, as can be seen from FIG. 4, or the mobile femtocell (mFBS1) 200 may directly receive service level (SL) information as necessary in step S2.

The mFBS1 100 having received the service level of the neighbor cell compares a service level (SL) of the neighbor cell with a service level (SL) of the mFBS1 100, and transmits a request for controlling Tx power of the neighbor mobile femtocell (mFBS2) 200 to the femtocell network controller (FNC) 400 according to the comparison result in step S3. For example, the mFBS1 100 may transmit a request for reducing Tx power of the mFBS2 200 to the FNC 400 when a service level of the neighbor cell (i.e., mFBS2) 200 is lower than that of the mFBS1 100 in step S3.

The FNC 400 having received the request for controlling Tx power of a specific cell transmits a command signal to the neighbor cell such that the neighbor cell can control Tx power according to the command signal in step S4. For example, if the mFBS1 100 transmits a request for reducing Tx power of the mFBS2 200 to the FNC 400 on the condition that a service level (SL) of the mFBS1 100 is lower than that of the mFBS2 200, the mFBS1 1100 may transmit a command signal for reducing Tx power to the mFBS2 200.

Finally, the neighbor cell having received the command signal from the FNC 400 may adjust Tx power according to a command of the FNC 400 in step S5. For example, if the FNC 400 transmits a command signal for reducing Tx power to the mFBS2 200, the mFBS2 200 having received the command signal may reduce its own Tx power.

The term “UE” disclosed in the above description may also be referred to as a device, and may include all kinds of UEs capable of implementing the embodiments of FIGS. 2 to 5. In other words, the UE (i.e., device) may conceptually include mobile communication terminals (e.g., a UE, a mobile phone, a cellular phone, a DMB phone, a DVB-H phone, a PDA phone, a PTT phone, etc.) capable of implementing technical idea of the present invention, a digital TV, a GPS navigation, a portable game machine, an MP3 player, and other household appliances, etc.

In addition, the user equipment (UE) according to the present invention includes software for implementing embodiments of FIGS. 1 to 4 and a module including the software. This module is one constituent element of the UE, and may be referred to as a processor or controller. The UE according to the present invention includes hardware and software requisite for executing technical features of the above-mentioned specification.

A variety of embodiments to be disclosed in the following description may be implemented by software, hardware, or a combination thereof. For example, the methods of the present invention can be stored in a storage medium (e.g. an internal memory of a mobile UE, a flash memory, a hard disk, etc.) and can be implemented into codes or commands in a software program executed by a processor (e.g. a microprocessor).

Although the present invention has been illustrated and described above with reference to the specific embodiments, the present invention is not limited to the specific embodiments and it will be apparent to those skilled in the art that various modifications can be made to the embodiments without departing from the scope of the present invention as disclosed in the accompanying claims and such modifications should not be construed as departing from the spirit or scope of the present invention.

The above-mentioned method for sharing a mobile femtocell network according to the present invention is not limitedly applicable to the constructions and methods of the embodiments as described above. For example, all or some of the embodiments may be selectively combined to achieve various modifications.

The above-mentioned embodiments have been disclosed with reference to the attached drawings.

Here, the terms or words used in the disclosure and the claims are not interpreted as having general meanings or dictionary meanings, but should be interpreted as having meanings and concepts coinciding with the technical scope and sprit of the present invention based on the principle in that an inventor may properly define the concept of terms to describe the present invention in the best mode.

Therefore, the embodiments described in the specification and shown in the drawings are purely illustrative and are not intended to represent all aspects of the invention, such that various equivalents and modifications may be made without departing from the spirit of the invention.

1. A method for sharing a mobile femtocell network by a mobile femtocell base station (BS), comprising:
receiving information on a service level (SL) of a neighbor mobile femtocell BS;
determining a service level of the neighbor mobile femtocell BS on the basis of the information on the service level (SL); and
transmitting a transmission (Tx) power control request for the neighbor mobile femtocell BS to a femtocell network controller (FNC) so as to reduce interference associated with the neighbor mobile femtocell BS according to a result of the determining.

2. The method according to claim 1, wherein the mobile femtocell BS is a mobile access point (AP).

3. The method according to claim 1, wherein the mobile femtocell BS is connected to a femtocell network controller (FNC) of a mobile communication core network (CN) through a macro BS.

4. The method according to claim 1, wherein the mobile femtocell BS communicates with UE (user equipment)s using either a mobile communication connection scheme or a WLAN scheme.

5. The method according to claim 1, wherein the neighbor mobile femtocell BS periodically transmits its own system information including the service level (SL) to the mobile femtocell BS.

6. The method according to claim 1, wherein the service level (SL) corresponds to priority in which a mobile femtocell BS having a higher SL is able to transmit at a higher transmission (Tx) power than a neighbor mobile femtocell having a lower SL.

7. The method according to claim 1, wherein the service level (SL) is set based on an accounting (or charging) level of a user.

8. The method according to claim 1, wherein the femtocell network controller (FNC) is present independently, or is integrated with a mobile management entity (MME) of a mobile communication core network (CN).

9. The method according to claim 1, wherein the information on the service level (SL) of the neighbor mobile femtocell is received through a user equipment (UE) or is directly received by the mobile femtocell BS.

10. The method according to claim 1, wherein the transmitting the transmission (Tx) power control request for the neighbor mobile femtocell to the FNC includes:
if a service level of the neighbor mobile femtocell is lower than that of the mobile femtocell BS, transmitting a request for reducing transmission (Tx) power of the neighbor mobile femtocell to the femtocell network controller (FNC).

11. A mobile femtocell base station (BS) for sharing a mobile femtocell network, comprising:
a receiver configured to receive information on a service level (SL) of a neighbor mobile femtocell; and
a controller configured to determine a service level (SL) of the neighbor mobile femtocell on the basis of the information on the service level (SL), and transmit a transmission (Tx) power control request for the neighbor mobile femtocell to a femtocell network controller (FNC) so as to reduce interference associated with the neighbor mobile femtocell according to a result of the determine.

12. The device according to claim 11, wherein the mobile femtocell BS is a mobile access point (AP).

13. The device according to claim 11, wherein the mobile femtocell BS is connected to a femtocell network controller (FNC) of a mobile communication core network (CN) through a macro BS.

14. The device according to claim 11, wherein the mobile femtocell BS communicates with UEs using either a mobile communication connection scheme or a WLAN scheme.

15. The device according to claim 11, wherein the neighbor mobile femtocell BS periodically transmits its own system information including the service level (SL).

16. The device according to claim 11, wherein the service level (SL) corresponds to priority in which a mobile femtocell BS having a higher SL is able to transmit at a higher transmission (Tx) power than a neighbor mobile femtocell having a lower SL.

17. The device according to claim 11, wherein the service level (SL) is set based on an accounting (or charging) level of a user.

18. The device according to claim 11, wherein the femtocell network controller (FNC) is present independently, or is integrated with a mobile management entity (MME) of a mobile communication core network (CN).

19. The device according to claim 11, wherein:
the information on the service level (SL) of the neighbor mobile femtocell is received through a user equipment (UE) or is directly received the service level (SL) information.

20. The device according to claim 11, wherein:
if a service level of the neighbor mobile femtocell is lower than that of the mobile femtocell BS, the mobile femtocell BS is configured to transmit a request for reducing transmission (Tx) power of the neighbor mobile femtocell to the femtocell network controller (FNC).
